(19) United States
(12) Patent Application Publication
(10) Pub. No.: US 2020/0132914 A1
(43) Pub. Date: Apr. 30, 2020

(54) BACKLIGHT UNIT AND DISPLAY DEVICE HAVING THE SAME

(71) Applicant: Samsung Display Co. Ltd., Yongin-si (KR)

(72) Inventors: Hee Kwang SONG, Suwon-si (KR); Hyun Jeong KIM, Hwaseong-si (KR)

(21) Appl. No.: 16/653,634

(22) Filed: Oct. 15, 2019

(30) Foreign Application Priority Data
Oct. 29, 2018 (KR) 10-2018-0129945

(51) Int. Cl. F21V 8/00

(52) U.S. Cl. CPC G02B 6/0053; G02B 6/0051; G02B 6/0056

(57) ABSTRACT

A backlight unit comprising a light guide plate, a wavelength conversion layer disposed on the light guide plate and an optical film disposed on the wavelength conversion layer. The optical film includes a first film including a prism pattern layer, and a first low-refractive layer disposed on the first film and having a complementary shape to the prism pattern layer. The first low-refractive layer has a refractive index smaller than a refractive index of the first film.

This application claims priority to Korean Patent Application No. 10-2018-0129945, filed on Oct. 29, 2018, and all the benefits accruing therefrom under 35 U.S.C. § 119, the content of which in its entirety is herein incorporated by reference.

### BACKGROUND

### 1. Field

The disclosure relates to a backlight unit and a display device including the backlight unit.

### 2. Description of the Related Art

A liquid-crystal display device typically receives light from a backlight unit and displays an image using the light. Such a backlight unit may include a light source and a light guide plate. The light guide plate receives light from the light source and guides the light toward the display panel. In a display device, the light source provides white light, and the white light is filtered by a color filter in the display panel to display a color.

Recently, a wavelength conversion material is used for a liquid-crystal display device to improve image quality such as color gamut thereof. In such a liquid-crystal display device, when a light source for emitting a near-ultraviolet light is employed, the absorption efficiency of the wavelength conversion material may be improved.

### SUMMARY

In a liquid-crystal display device including a light source for emitting a near-ultraviolet light, the recycling effects of the wavelength conversion material along the reflection path may not be effectively achieved. Accordingly, an optical film that can improve brightness by minimizing the reflection mechanism of the light source is desired.

Embodiments of the disclosure provide a backlight unit with improved brightness.

Embodiments of the disclosure also provide a display device that with improved brightness.

According to an exemplary embodiment of the invention, a backlight unit includes a light guide plate, a wavelength conversion layer disposed on the light guide plate and an optical film disposed on the wavelength conversion layer. In such an embodiment, the optical film includes a first film including a prism pattern layer, and a first low-refractive layer disposed on the first film and having a complementary shape to the prism pattern layer, where the first low-refractive layer has a refractive index less than has a refractive index of the first film.

In an exemplary embodiment, the refractive index of the first low-refractive layer may be in a range from about 1.2 to about 1.28.

In an exemplary embodiment, an upper surface of the first low-refractive layer may be parallel to a lower surface of the first film.

In an exemplary embodiment, the prism pattern layer may include convex portions and concave portions. In such an embodiment, a first distance from a vertex of each of the convex portions to the upper surface of the first low-refractive layer may be smaller than a second distance from a vertex of each of the concave portions to the upper surface of the first low-refractive layer.

In an exemplary embodiment, the backlight unit may include a second low-refractive layer between the light guide plate and the wavelength conversion layer. In such an embodiment, the second low-refractive layer may be in contact with the light guide plate.

In an exemplary embodiment, a refractive index of the second low-refractive layer may be equal to the refractive index of the first low-refractive layer.

In an exemplary embodiment, the backlight unit may include a light source disposed adjacent to at least one side of the light guide plate.

In an exemplary embodiment, the light source may emit a first light and a second light. In such an embodiment, the first light may be a near-ultraviolet light having a peak wavelength between about 390 nanometers (nm) and about 410 nm, and the second light may be a blue light having a peak wavelength between about 430 nm and about 470 nm.

In an exemplary embodiment, the wavelength conversion layer may include a first wavelength conversion material and a second wavelength conversion material. In such an embodiment, the he first wavelength conversion material may convert light emitted from the light source into a green light, and the second wavelength conversion material may convert the light emitted from the light source into a red light.

In an exemplary embodiment, the backlight unit may further include a second film disposed between the first film and the wavelength conversion layer, where the second film includes a scattering layer.

In an exemplary embodiment, the optical film may further include a third film including a prism pattern disposed on the first low-refractive layer, and a fourth film including a reflective polarizing layer.

In an exemplary embodiment, the optical film may further include a protective layer. In such an embodiment, the protective layer may be in contact with a lower surface of the first film, contact with side surfaces of each of the first film, the second film and the first low-refractive layer, and contact with an upper surface of the first low-refractive layer.

In an exemplary embodiment, the backlight unit may further include a reflection member disposed under the light guide plate.

In an exemplary embodiment, the light guide plate may include a scattering pattern disposed on a surface opposite to a surface facing the wavelength conversion layer.

According to another exemplary embodiment of the invention, a display device includes a backlight unit including a light guide plate, a wavelength conversion layer disposed on the light guide plate, and an optical film disposed on the wavelength conversion layer, a light source disposed on at least one side of the light guide plate, and a display panel disposed above the backlight unit. In such an embodiment, the optical film includes a first film including a prism pattern layer, and a first low-refractive layer disposed on the first film and having a complementary shape to the prism pattern layer, where the first low-refractive layer has a refractive index less than a refractive index of the first film.

In an exemplary embodiment, the refractive index of the first low-refractive layer may be in a range from about 1.2 to about 1.28.

In an exemplary embodiment, an upper surface of the first low-refractive layer may be parallel to a lower surface of the first film.

In an exemplary embodiment, the display device may further include a second film disposed between the first film and the wavelength conversion layer and including a scattering layer.

In an exemplary embodiment, the light source may emit a first light and a second light, where the first light may be a near-ultraviolet light having a peak wavelength between about 390 nm and about 410 nm, and the second light may be a blue light having a peak wavelength between about 430 nm and about 470 nm.

In an exemplary embodiment, the display device may further include an inter-module coupling member disposed at an edge of the wavelength conversion layer, where the inter-module coupling member couples the light guide plate with the display panel. In such an embodiment, the optical film may be disposed in a space surrounded by the light guide plate, the display panel and the inter-module coupling member.

According to exemplary embodiments of the disclosure, the brightness of a backlight unit may be improved by reducing optical loss due to a stack of optical films.

### BRIEF DESCRIPTION OF THE DRAWINGS

The above and other features of the disclosure will become more apparent by describing in detail exemplary embodiments thereof with reference to the attached drawings, in which:

FIG. 1 is a perspective view of a backlight unit according to an exemplary embodiment of the disclosure;

FIG. 2 is a cross-sectional view taken along line II-II′ of FIG. 1;

FIGS. 3 and 4 are cross-sectional views of a first low-refractive layer according to various exemplary embodiments of the disclosure;

FIG. 5 is a cross-sectional view of a wavelength conversion layer;

FIG. 6 is a graph schematically showing the absorption efficiencies of the wavelength conversion materials;

FIG. 7 is a graph for comparing the luminous flux (the amount) of light exiting from the wavelength conversion layer when the light source emits blue light with the amount of the light exiting from the wavelength conversion layer when the light source emits near-ultraviolet light;

FIG. 8 is a graph for comparing luminous fluxes between optical film layers having different stack structures when a blue light passes through them;

FIG. 9 is a graph for comparing luminous fluxes between optical film layers having different stack structures when a near-ultraviolet light passes through them;

FIG. 10 is a view schematically showing various paths in which lights travel after they have passed through the prism film;

FIGS. 11 to 14 are cross-sectional views of backlight units according to a variety of exemplary embodiments;

FIG. 15 is a cross-sectional view of a backlight unit according to yet another exemplary embodiment of the disclosure; and

FIGS. 16 to 18 are cross-sectional views of display devices according to exemplary embodiments of the disclosure.

### DETAILED DESCRIPTION OF THE EMBODIMENTS

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Where an element is described as being related to another element such as being “on” another element or “located on” a different layer or a layer, includes both a case where an element is located directly on another element or a layer and a case where an element is located on another element via another layer or still another element. In contrast, where an element is described as being is related to another element such as being “directly on” another element or “located directly on” a different layer or a layer, indicates a case where an element is located on another element or a layer with no intervening element or layer therebetween.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” “At least one of A and B” means “A and/or B.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described with reference to the accompanying drawings

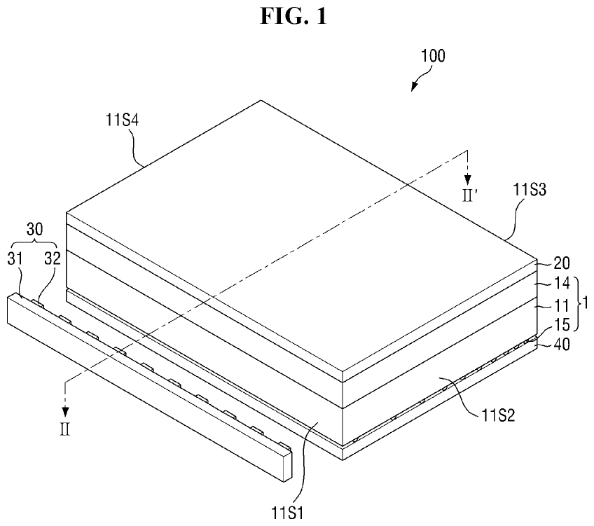

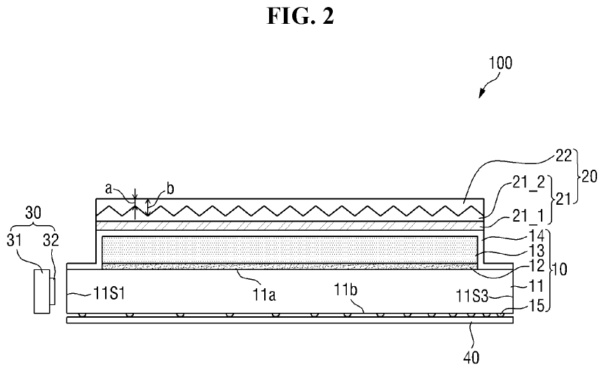

FIG. 1 is a perspective view of a backlight unit according to an exemplary embodiment of the disclosure. FIG. 2 is a cross-sectional view taken along line II-II′ of FIG. 1.

Referring to FIGS. 1 and 2, an exemplary embodiment of a backlight unit 100 includes an optical member 10, an optical film layer 20 disposed on the optical member 10, and a light source 30 disposed on a side surface of the optical member 10. The backlight unit 100 may further include a reflection member 40 disposed below the optical member 10.

In an exemplary embodiment, as shown in FIG. 2, the optical member 10 may include a light guide plate 11, a first low-refractive layer 12 disposed on the light guide plate 11, a wavelength conversion layer 13 disposed on the first low-refractive layer 12, and a protective layer 14 disposed on the wavelength conversion layer 13. The optical member 10 may further include a scattering pattern 15 disposed on a lower surface 11b of the light guide plate 11.

The light guide plate 11 guides light incident thereto in predetermined directions. The light guide plate 11 may have a generally polygonal column shape. The shape of the light guide plate 11 may be, but is not limited to being, a rectangle when viewed from a top plan view or a plan view in a thickness direction thereof. In an exemplary embodiment, the light guide plate 11 has a rectangular hexahedron shape looking like a rectangle when viewed from the top plan view and may include an upper surface 11a, a lower surface 11b and four side surfaces 11S1, 11S2, 11S3 and 11S4. In the following description and the accompanying drawings, the four side surfaces may be denoted by “11S1,” “11S2,” “11S3” and “11S4,” respectively, to distinguish one from another for convenience of description. However, each of the four side surfaces may be denoted by “11S” when only one of the four side surfaces is referred.

In an exemplary embodiment, the upper surface 11a and the lower surface 11b of the light guide plate 11 are positioned in planes, respectively, and the plane in which the upper surface 11a is located is generally parallel to the plane in which the lower surface 11b is located, such that the light guide plate 11 may have a uniform thickness. However, the disclosure is not limited thereto. Alternatively, the upper surface 11a or the lower surface 11b may include a plurality of planes, or the plane where the upper surface 11a is located may intersect with the plane where the lower surface 11b is located. In one exemplary embodiment, for example, the light guide plate 11 may have a wedge-shape such that the thickness thereof may become smaller from one side (e.g., the light incidence surface) to the other side (e.g., the opposite surface) opposed thereto. Alternatively, the lower surface 11b may be inclined upwardly such that the thickness of the light guide plate 11 may be reduced in the vicinity of one side (e.g., the light incidence surface) toward the other side (e.g., the opposite surface) to a certain position and then the upper surface 11a and the lower surface 11b may become planar or parallel to each other .

The planes where the upper surface 11a and/or the lower surface 11b are located may form an angle of about 90° with respect to each of the planes where the side surfaces 11S are located. In some exemplary embodiments, the light guide plate 11 may further include an inclined surface between the upper surface 11a and one side surface 11S and/or between the lower surface 11b and one side surface 11S. Hereinafter, exemplary embodiments where the upper surface meets the side surfaces directly at the angle of 90° without an inclined surface will be described for convenience of description.

A scattering pattern 15 may be disposed on the lower surface 11b of the light guide plate 11. The scattering pattern 15 serves to change the angle of the light traveling in the light guide plate 11 by total reflection to allow the light to exit out of the light guide plate 11.

In an exemplary embodiment, the scattering pattern 15 may be implemented as or defined by a separate layer or a pattern. In one exemplary embodiment, for example, a pattern layer including a protruding pattern and/or a depressed groove pattern may be defined on the lower surface 11b of the light guide plate 11 or a printed pattern may be provided thereon to function as the scattering pattern 15.

In an alternative exemplary embodiment, a surface of the light guide plate 11 itself may function as the scattering pattern 15. In one exemplary embodiment, for example, depressed grooves may be defined or formed in the lower surface 11b of the light guide plate 11, the lower surface 11b may serve as the scattering pattern 15.

The scattering pattern 15 may have different densities depending on the regions thereof. In one exemplary embodiment, for example, the scattering pattern may have a lower density adjacent to the light incidence surface 11S1 where an amount of light incident thereto is greater, and may have a higher density adjacent to the opposite surface 11S3 where an amount of light incident thereto is less.

The light guide plate 11 may include an inorganic material. In one exemplary embodiment, for example, the light guide plate 11 may include or be made of, but is not limited to, glass.

The backlight unit 100 may include the light source 30 disposed on one side surface of the light guide plate 11 to face the one side thereof.

The light source 30 may be disposed adjacent to at least one side surface 11S of the light guide plate 11. In an exemplary embodiment, as shown in FIG. 1, a printed circuit board 31 and a plurality of light-emitting elements 32 mounted on the printed circuit board 31 are disposed adjacent to the side surface 11S1 located at the longer side of the light guide plate 11, but the disclosure is not limited thereto. In one exemplary embodiment, for example, the light-emitting elements 32 may be disposed adjacent to opposing side surfaces 11S1 and 11S3 on the longer sides, respectively, or may be disposed adjacent to one or both of the side surfaces 11S2 and 11S4 on the shorter sides, respectively. In an exemplary embodiment, as shown in FIGS. 1 and 2, the side surface 11S1 of the longer side of the light guide plate 11, which the light source 30 is disposed to face, serves as or defines the light incidence surface onto which light is directly incident (denoted by 11S1 in the drawings). The side surface 11S3 of the other longer side opposite thereto serves as or defines the opposite surface (denoted by 11S3 in the drawings).

The light source 30 may include a point light source or a line light source. The point light source may include light-emitting diodes (“LED”s). The light-emitting elements 32 may emit blue light or near-ultraviolet light. In one exemplary embodiment, for example, the light-emitting elements 32 that emit blue light may be arranged at odd-numbered positions of the circuit board 31 while the light-emitting elements 32 that emit near-ultraviolet light may be arranged at odd-numbered positions of the circuit board 31, such that the light-emitting elements 32 that emit blue light and the light-emitting elements 32 that emit near-ultraviolet light are arranged alternately with each other. In an alternative exemplary embodiment, a blue fluorescent material may be included on the light-emitting elements 32 that emit near-ultraviolet light.

The blue light may be light in a blue wavelength band. In an exemplary embodiment, the blue light emitted from the light-emitting elements 32 may have a peak wavelength in a range between about 430 nm and about 470 nm. The blue light emitted from the light-emitting elements 32 may be incident into the light guide plate 11 through the light incidence surface 11S1.

The light emitted from the light-emitting elements 32 that emit a near-ultraviolet light may in a shorter wavelength band than light om a blue wavelength band. In an exemplary embodiment, the near-ultraviolet light emitted from the light-emitting elements 32 may be a light having a peak wavelength in a range between about 390 nm and about 410 nm. The near-ultraviolet light emitted from the light-emitting elements 32 may be incident into the light guide plate 11 through the light incidence surface 11S1.

In an exemplary embodiment, as shown in FIG. 2, the first low-refractive layer 12 may be disposed on the upper surface 11a of the light guide plate 11. The first low-refractive layer 12 may be formed directly on the upper surface 11a of the light guide plate 11 and may disposed to contact the upper surface 11a of the light guide plate 11. The low-refractive layer 12 is interposed between the light guide plate 11 and the wavelength conversion layer 13 to facilitate the total reflection of light guided by the light guide plate 11.

In such an embodiment, it is desired effective total internal reflection to occur on the upper surface 11a and the lower surface 11b of the light guide plate 11 to efficiently guide light toward the opposite surface 11S3 from the light incidence surface 11S1 by the light guide plate 11. In such an embodiment, the refractive index of the light guide plate 11 is greater than the refractive index of the medium that forms an optical interface with the light guide plate 11 to effectively achieve the total internal reflection in the light guide plate 11. As the refractive index of the medium that forms the optical interface with the light guide plate 11 is lower, the critical angle for the total reflection becomes smaller, so that more total internal reflection may be achieved.

In an embodiment, where the light guide plate 11 is made of glass having the refractive index of approximately 1.5, the lower surface 11b of the light guide plate 11 is exposed to the air layer having the refractive index of approximately 1 to form the optical interface with the light guide plate 11, and thus the total reflection may be effectively achieved.

In such an embodiment, since other optical functional layers are stacked or integrated on the upper surface 11a of the light guide plate 11, sufficient total reflection may not be achieved on the upper surface 11a compared to the lower surface 11b. If a material layer having a refractive index of 1.5 or greater is stacked on the upper surface 11a of the light guide plate 11, the total reflection may not be achieved on the upper surface 11a of the light guide plate 11. If a material layer having a refractive index slightly less than that of the light guide plate 11, e.g., the refractive index of approximately 1.49, is stacked on the upper surface 11a of the light guide plate 11, the total reflection may not be effectively achieved since the critical angle becomes too greater although total internal reflection may occur on the upper surface 11a of the light guide plate 11. Conventionally, the wavelength conversion layer 13 stacked on the upper surface 11a of the light guide plate 11 typically has a refractive index of approximately 1.5. When such a wavelength conversion layer 13 is stacked directly on the upper surface 11a of the light guide plate 11, sufficient total reflection may not be achieved on the upper surface 11a of the light guide plate 11.

In an exemplary embodiment, as shown in FIG. 2, the first low-refractive layer 12 is interposed between the light guide plate 11 and the wavelength conversion layer 13 to form the interface with the upper surface 11a of the light guide plate 11 and has a refractive index lower than that of the light guide plate 11, so that the total reflection may effectively occur on the upper surface 11a of the light guide plate 11. In such an embodiment, the first low-refractive layer 12 has a refractive index lower than that of the wavelength conversion layer 13 that is the material layer disposed thereon, so that more total reflection may be achieved compared to when the wavelength conversion layer 13 is disposed directly on the upper surface 11a of the light guide plate 11.

In an exemplary embodiment, the difference in refractive index between the light guide plate 11 and the first low-refractive layer 12 may be about 0.2 or greater. When the refractive index of the first low-refractive layer 12 is less than the refractive index of the light guide plate 11 by 0.2 or greater, a sufficient total reflection may be achieved by the upper surface 11a of the light guide plate 11. The difference between the refractive index of the light guide plate 11 and the refractive index of the first low-refractive layer 12 may not have an upper limit. However, in an exemplary embodiment, the difference in refractive index between the light guide plate 11 and the first low-refractive layer 12 may be 0.5 or less considering the refractive indices of typical materials of the light guide plate 11 and the low-refractive layer 12.

The refractive index of the first low-refractive layer 12 may be in a range from about 1.2 to about 1.4. Typically, the fabricating cost is exponentially increased as the refractive index of a solid medium approaches one. If the refractive index of the first low-refractive layer 12 is 1.2 or less, the fabricating cost may be too great. In such an embodiment, if the refractive index of the first low-refractive layer 12 is 1.4 or greater, the total reflection critical angle of the upper surface 11 a of the light guide plate 11 may not be sufficiently small. In one exemplary embodiment, for example, the first low-refractive layer 12 having a refractive index of approximately 1.25 may be employed.

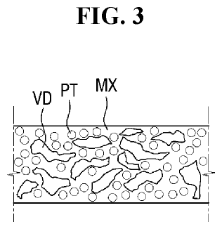

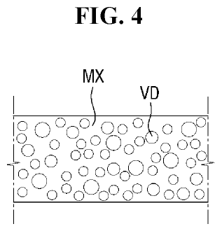

The first low-refractive layer 12 may include voids (or empty spaces defines therein) to achieve the above-mentioned low refractive index. The voids may be made in vacuum or may be filled with air, a gas, or the like. The space of the voids may be defined by particles, matrix, and so on. Exemplary embodiments of the first low-refractive layer 12 including the voids will hereinafter be described in greater detail with reference to FIGS. 3 and 4.

FIGS. 3 and 4 are cross-sectional views of a first low-refractive layer according to various exemplary embodiments of the disclosure.

In an exemplary embodiment, the first low-refractive layer 12 may include a plurality of particles PT, a matrix MX which surrounds the particles PT as a single piece, and voids VD as shown in FIG. 3. The particles PT may function as a filler that adjusts the refractive index and the mechanical strength of the first low-refractive layer 12.

The particles PT may be dispersed inside the matrix MX of the first low-refractive layer 12, and the matrix MX may be partially opened so that the voids VD may be formed in the opened portions. In one exemplary embodiment, for example, the particles PT and the matrix MX may be mixed in a solvent, and then may be dried and/or cured so that the solvent evaporates, thereby forming the voids VD between the opened portions of the matrix MX.

In an alternative exemplary embodiment, the first low-refractive layer 12 may include a matrix MX and voids VD without particles PT, as shown in FIG. 4. In one exemplary embodiment, for example, the first low-refractive layer 12 may include a matrix MX integrally formed as a single unitary unit, such as a foaming resin, and voids VD formed therein.

In such an embodiment, as shown in FIGS. 3 and 4, where the first low-refractive layer 12 includes voids VD, the overall refractive index of the first low-refractive layer 12 may be between the refractive indices of the particles PT/the matrix MX and the refractive index of the voids VD. In such an embodiment, where the voids VD are in a vacuum state to have a refractive index of one or are filled with an air, gas, etc. having a refractive index of approximately one as described above, the overall refractive index of the first low-refractive layer 12 may have a value of about 1.4 or less, e.g., approximately 1.25, even when a material having a refractive index of about 1.4 or greater is used as the particles PT/matrix MX. In an exemplary embodiment, the particles PT may include or be made of an inorganic material such as SiO₂, Fe₂O₃ and MgF₂, and the matrix MX may include or be made of an organic material such as polysiloxane, but not being limited thereto. Alternatively, the particles PT and the matrix MX may be made of other organic or inorganic materials.

Referring back to FIGS. 1 and 2, in an exemplary embodiment, the thickness of the first low-refractive layer 12 may be in a range from about 0.4 micrometer (μm) to about 2 μm. In such an embodiment, the thickness of the first low-refractive layer 12 is about 0.4 μm or greater, which is the visible light wavelength range, such that an effective optical interface may be formed with the upper surface 11a of the light guide plate 11 to allow the overall total reflection according to Snell's law to effectively occur on the upper surface 11a of the light guide plate 11. In such an embodiment, if the first low-refractive layer 12 is too thick, the thickness of the optical member 10 may be increased, such that the fabricating cost may be increased, and the brightness of the optical member 10 may be lowered. Accordingly, in an exemplary embodiment, the first low-refractive layer 12 may have a thickness of 2μm or less.

In an exemplary embodiment, the first low-refractive layer 12 covers most of the upper surface 11a of the light guide plate 11 and may expose a part of the edge of the light guide plate 11. In such an embodiment, the side surfaces 11S of the light guide plate 11 may protrude from the side surfaces of the first low-refractive layer 12, respectively. As the upper surface 11a is exposed, the first protective layer 14 may stably cover the side surfaces of the first low-refractive layer 12.

In an alternative exemplary embodiment, the first low-refractive layer 12 may completely cover the upper surface 11a of the light guide plate 11. The side surfaces of the first low-refractive layer 12 may be aligned with the side surfaces of the light guide plate 11, respectively. In such embodiment, the covering of the first low-refractive layer 12 may be determined depending on the fabricating process of the light guide plate 11.

The first low-refractive layer 12 may be formed by a coating, for example. In one exemplary embodiment, for example, the first low-refractive layer 12 may be formed by coating a composition for the low-refractive layer on the upper surface 11a of the light guide plate 11, followed by drying and curing. The composition for the low-refractive layer may be coated by, but is not limited to, a slit coating, a spin coating, a roll coating, a spray coating or using an ink jet. It is, however, to be understood that the composition may be stacked in a variety of ways.

Although not shown in the drawings, a barrier layer may be further disposed between the first low-refractive layer 12 and the light guide plate 11. The barrier layer may cover the entire upper surface 11a of the light guide plate 11. The side surfaces of the barrier layer may be aligned with the side surfaces 11S of the light guide plate 11, respectively. In such an embodiment, the first low-refractive layer 12 may be disposed or formed on the upper surface of the barrier layer. The first low-refractive layer 12 may expose a part of the edge of the barrier layer.

The barrier layer serves to prevent permeation of impurities, such as moisture and oxygen, into the first protective layer 14 to be described later. The barrier layer may include an inorganic material. In one exemplary embodiment, for example, the barrier layer may include at least one selected form silicon nitride, aluminum nitride, zirconium nitride, titanium nitride, hafnium nitride, tantalum nitride, silicon oxide, aluminum oxide, titanium oxide, tin oxide, cerium oxide and silicon oxynitride, or a metal thin film with light transmittance. The barrier layer may include or be made of, but is not limited to being, a same material as the first protective layer 14. The barrier layer may be formed by a chemical vapor deposition or the like.

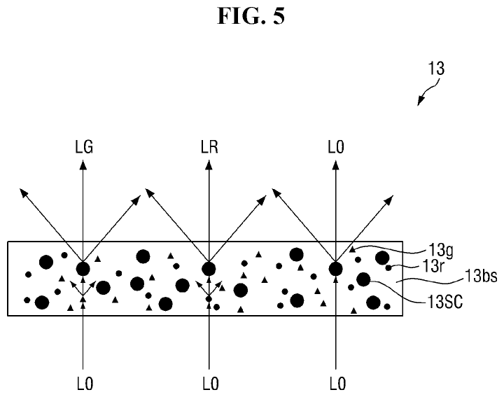

In an exemplary embodiment, as shown in FIG. 2, the wavelength conversion layer 13 is disposed on the upper surface of the first low-refractive layer 12. The wavelength conversion layer 13 converts the wavelength of at least a part of incident light. The wavelength conversion layer 13 may include a binder layer and wavelength conversion materials dispersed in the binder layer. The wavelength conversion layer 13 may further include scattering particles 13SC (shown in FIG. 5) dispersed in the binder layer in addition to the wavelength conversion material.

The wavelength conversion layer 13 will be described in greater detail with reference to FIG. 5.

FIG. 5 is a cross-sectional view of a wavelength conversion layer.

Referring to FIG. 5, the wavelength conversion layer 13 may include a binder layer 13bs, and a first wavelength conversion material 13g, a second wavelength conversion material 13r and scattering particles 13SC, which are dispersed in the binder layer 13bs.

The binder layer 13bs is a medium in which the wavelength conversion materials 13g and 13r are dispersed, and may include or be made of at least one of various resin compositions, which may be generally referred to as binders. It is, however, to be understood that the disclosure is not limited thereto. Any medium may be referred to as the binder layer irrespective of its name, other additional functionality and its constituent materials, as long as it can disperse the wavelength conversion materials and/or the scattering particles therein.

The wavelength conversion materials 13g and 13r are for converting the wavelength of incident light, and may be, for example, quantum dots (“QD”), a fluorescent material, or a phosphorescent material. Hereinafter, for convenience of description, exemplary embodiments where the wavelength conversion materials 13g and 13r are QDs will be described in detail, but the disclosure is not limited thereto.

A QD is a material with a crystal structure of several nanometers in size, and consists of hundreds to thousands of atoms. The QD exhibits the quantum confinement effect which leads to an increase in the energy band gap due to the small size thereof. When a light of a wavelength having an energy level higher than the bandgap is incident on a QD, the QD is excited by absorbing the light and relaxed to the ground state while emitting light of a particular wavelength. The exiting light of the wavelength has a value corresponding to the band gap. By adjusting the size and composition of the QDs, the luminescence characteristics due to the quantum confinement effect can be adjusted.

A QD may include, for example, at least one selected from a group II-VI compound, a group II-V compound, a group III-VI compound, a group III-V compound, a group IV-VI compound, a group compound, a group II-IV-VI compound, and a group II-IV-V compound.

A QD may include a core and a shell overcoating the core. The core may be, but not limited to, at least one selected from CdS, CdSe, CdTe, ZnS, ZnSe, ZnTe, GaN, GaP, GaAs, GaSb, AIN, AlP, AlAs, AlSb, InP, InAs, InSb, SiC, Ca, Se, In, P, Fe, Pt, Ni, Co, Al, Ag, Au, Cu, FePt, Fe2O3, Fe3O4, Si and Ge. The shell may include, but not limited to, at least one selected from ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe and PbTe.

The wavelength conversion layer 13 may include a plurality of wavelength conversion materials 13g and 13r for converting the light LO incident on the wavelength conversion layer 13 into lights having different wavelengths. In one exemplary embodiment, for example, the wavelength conversion layer 13 may include a first wavelength conversion material 13g that converts the incident light LO having a certain wavelength into a first light LG having a first wavelength to pass the first light LG, and a second wavelength conversion material 13r that converts it into a second light LR having a second wavelength to pass the second light LR. In an exemplary embodiment, the first wavelength may be a green wavelength and the second wavelength may be a red wavelength. In one exemplary embodiment, for example, the green wavelength may have a peak between about 520 nm and about 570 nm, and the red wavelength may have a peak between about 620 nm and about 670 nm. In such an embodiment, the first light may be a green light, and the second light may be a red light.

The first wavelength conversion material 13g may have a lower light absorption efficiency than the second wavelength conversion material 13r. Accordingly, even if the same amount of light is incident, the amount of light converted by the second wavelength conversion material 13r may be the greater. Therefore, in such an embodiment, the number of particles of the first wavelength conversion material 13g may be greater than the number of particles of the second wavelength conversion material 13r in a unit volume of the wavelength conversion layer 13. In one exemplary embodiment, for example, the number of particles of the first wavelength conversion material 13g may be about 1.5 times to 2.5 times greater than the number of particles of the second wavelength conversion material 13r.

The wavelength of the light LO incident on the wavelength conversion layer 13 may have a peak wavelength shorter than the peak wavelengths of the first light LG and the second light LR.

In an exemplary embodiment, the incident light LO may have a peak between about 420 nm and about 470 nm. In such an embodiment, the incident light L0 may be a blue light. The blue light incident on the wavelength conversion layer 13 passes through the wavelength conversion layer 13, such that a part of the blue light is incident on the first wavelength conversion particles to be converted into the green wavelength and exits. Another part of the blue light is incident on the second wavelength conversion particles to be converted into the red wavelength and exits. The other part of the blue light is incident neither on the first wavelength conversion particles nor on the second wavelength conversion particles, and may exit as it is. Accordingly, the light passed through the wavelength conversion layer 13 includes all of the blue wavelength light, the green wavelength light and the red wavelength light. In such an embodiment, white light or light of another color may be displayed by adjusting the ratio of the exiting lights of different wavelengths.

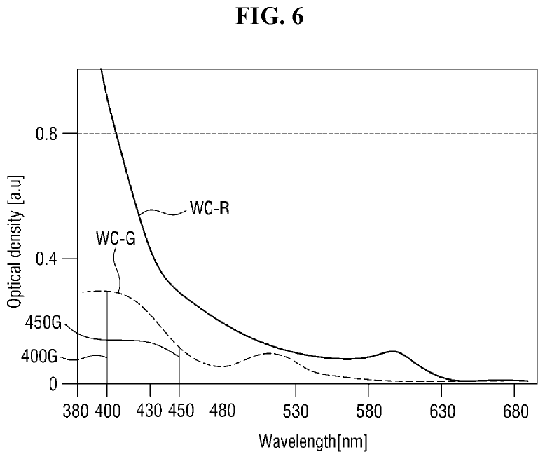

In an alternative exemplary embodiment, the incident light LO may have a peak wavelength between about 390 nm and about 410 nm. In such an embodiment, the incident light L0 may be near-ultraviolet (also referred to as “nUV”) light. When the near-ultraviolet light having a shorter peak wavelength than the blue light is used as the incident light L0, the wavelength conversion layer 13 may have a higher light absorption efficiency than the blue light. The light absorption efficiency will be described later in greater detail with reference to FIG. 6.

In such an embodiment, when the near-ultraviolet light is incident on the wavelength conversion layer 13, a part of the near-ultraviolet light is incident on the first wavelength conversion material 13g and is converted into the first light LG, another part of the near-ultraviolet light is incident on the second wavelength conversion material 13r and is converted into the second light LR, and the rest part of the near-ultraviolet light is incident on neither the first wavelength conversion material 13g and nor the second wavelength conversion material 13r and exits as it is. Accordingly, the lights having passed through the wavelength conversion layer 13 include the first light LG, the second light LR and the incident light L0. If the incident light LO is near-ultraviolet light, the light may be out of the visible light range and thus may not be perceived by the user. Therefore, only the first light LG and the second light LR of the light having passed through the wavelength conversion layer 13 can be perceived as a yellow light, for example. In an exemplary embodiment, where the incident light L0 is a blue light, the first light LG, the second light LR and the incident light L0 of the light having passed through the wavelength conversion layer 13 can be perceived as a white light, for example.

The lights converted in the wavelength conversion layer 13 are concentrated within a narrow range of specific wavelengths and have a sharp spectrum with a narrow half width. Therefore, by filtering the light of such spectrum with a color filter to reproduce colors, the color gamut may be improved.

The wavelength conversion layer 13 may further include scattering particles 13SC. The scattering particles 13SC may be non-quantum dots, which do not perform a wavelength conversion. The scattering particles 13SC scatter the incident light to various directions such that more incident light is allowed to be incident on the wavelength conversion particles. In such an embodiment, the scattering particles 13SC may regulate the exit angles of lights having different wavelengths. In such an embodiment, when a part of the incident light is incident on the wavelength conversion materials and then the wavelength is converted and exits, the exiting light may scatter in random directions by the scattering particles 13SC. In such an embodiment, where the scattering particles 13SC are included in the wavelength conversion layer 13, the scattering characteristics of the exiting first light LG and the second light LR after collisions with the wavelength conversion materials 13g and 13r may be further improved, such that the viewing angle of the display device may be improved. In an exemplary embodiment, TiO₂, SiO₂ and the like may be used as the scattering particles 13SC.

Referring back to FIGS. 1 and 2, the wavelength conversion layer 13 may be thicker than the first low-refractive layer 12. The thickness of the wavelength conversion layer 13 may be in a range from about 10 μm to about 50 μm. In one exemplary embodiment, for example, the thickness of the wavelength conversion layer 13 may be approximately 15 μm.

The wavelength conversion layer 13 may cover the upper surface of the first low-refractive layer 12 and may completely overlap the first low-refractive layer 12 when viewed from a plan view in a thickness direction of the first low-refractive layer 12 or the wavelength conversion layer 13. The lower surface of the wavelength conversion layer 13 may be in direct contact with the upper surface of the first low-refractive layer 12. In an exemplary embodiment, the side surfaces of the wavelength conversion layer 13 may be aligned with the side surfaces of the first low-refractive layer 12 when viewed from the plan view. In FIG. 2, the side surfaces of the wavelength conversion layer 13 are aligned with the side surfaces of the first low-refractive layer 12, respectively, on the upper surface 11a of the light guide plate 11. In an alternative exemplary embodiment, the side surfaces of the wavelength conversion layer 13 and the side surfaces of the first low-refractive layer 12 may be disposed on the upper surface 11a of the light guide plate 11 at inclination angles less than 90 degrees. In such an embodiment, the angle of the side surfaces of the wavelength conversion layer 13 may be less than the angle of the side surfaces of the first low-refractive layer 12. When the wavelength conversion layer 13 is formed by a slit coating or the like, which will be described later, the side surfaces of the relatively thick wavelength conversion layer 13 may have a gentler inclination angle than that of the side surfaces of the first low-refractive layer 12. It is, however, to be understood that the disclosure is not limited thereto. Depending on the method of the wavelength conversion layer 13, the inclination angle of the side surfaces of the wavelength conversion layer 13 may be substantially equal to or less than the inclination angle of the side surfaces of the first low-refractive layer 12.

The wavelength conversion layer 13 may be formed by a coating and the like. In one exemplary embodiment, for example, a wavelength conversion composition may be slit-coated on the light guide plate 11 where the first low-refractive layer 12 is formed, and then it is dried and cured to form the wavelength conversion layer 13. It is, however, to be understood that the disclosure is not limited thereto. The wavelength conversion layer 13 may be formed in a variety of other ways.

In an exemplary embodiment, as described above, the wavelength conversion layer 13 is continuously formed on the light guide plate 11, but the disclosure is not limited thereto. In an alternative exemplary embodiment, the wavelength conversion layer 13 may be implemented in the form of a wavelength conversion film. The wavelength conversion film may be formed by stacking barrier films on and under the wavelength conversion layer 13, thereby effectively preventing the permeation of impurities such as moisture and oxygen. The wavelength conversion film including the wavelength conversion layer 13 may be attached to the light guide plate 11 by an adhesive material such as an optically clear resin (“OCR”) and an optically clear adhesive (“OCA”).

FIG. 6 is a graph schematically showing the absorption efficiencies of the wavelength conversion materials. The wavelength conversion materials illustrated in FIG. 6 may be the first wavelength conversion material 13g and the second wavelength conversion material 13r described above with respect to FIG. 5. In the graph of FIG. 6, the x-axis represents the wavelength of the incident light, and the y-axis represents the light absorption efficiency. The higher the light absorption efficiency, the more light can be absorbed and converted, and exit.

Referring to FIGS. 5 and 6, a first curve WC-G shows the light absorption efficiency of the first wavelength conversion material 13g versus wavelength, and a second curve WC-R shows the light absorption efficiency of the second wavelength conversion material 13r versus wavelength.

Depending on the types of the wavelength conversion materials, the light absorption efficiency may be different even when light of the same wavelength is incident. As described above, the second wavelength conversion material 13r may have a higher light absorption efficiency than the first wavelength conversion material 13g.

As shown in FIG. 6, the second curve WC-R is generally located above the first curve WC-G. This means that the light absorption efficiency of the second wavelength conversion material 13r is higher than that of the first wavelength conversion material 13g in most wavelength bands. Therefore, in an exemplary embodiment, when the first wavelength conversion material 13g is dispersed more than the second wavelength conversion material 13r in the wavelength conversion layer 13, the amount of the first light LG converted by the first wavelength conversion material 13g may be equal to the amount of the second light LR converted by the second wavelength conversion material 13r.

In such an embodiment, the wavelength conversion materials may have different light absorption efficiencies depending on the wavelengths of the incident light. Typically, the wavelength conversion materials absorb more amount of light when light of a shorter wavelength band is incident.

Referring to the first curve WC-G, the absorption efficiency at the wavelength of 400 nm indicated by 400 G is higher than the absorption efficiency at the wavelength of 450 nm indicated by 450 G. Accordingly, when the amount of the incident light of the wavelength of 400 nm is equal to the amount of the incident light of the wavelength of 450 nm, the former may be more absorbed and may exit after its wavelength has been converted.

In an exemplary embodiment, the absorption efficiency (400 G) at the wavelength of 400 nm may be, but is not limited to, 1.5 to 2.5 times the absorption efficiency (450 G) at the wavelength of 450 nm. The light having the wavelength of 400 nm may be a near-ultraviolet light having a peak wavelength between 390 and 410 nm, and the light having the wavelength of 450 nm may be a blue light having a peak wavelength between 430 and 470 nm. Accordingly, the light absorption efficiency when the near-ultraviolet light is incident on the first wavelength conversion material 13g may be higher than the light absorption efficiency when the blue light is incident thereon.

In in a case where the light incident on the wavelength conversion layer 13 is near-ultraviolet light, even if a less amount of the light is incident, the same amount of light can exit as compared to a case where the blue light is incident. In other words, the power consumption of the backlight unit for generating incident light may be reduced when a near-ultraviolet light is used.

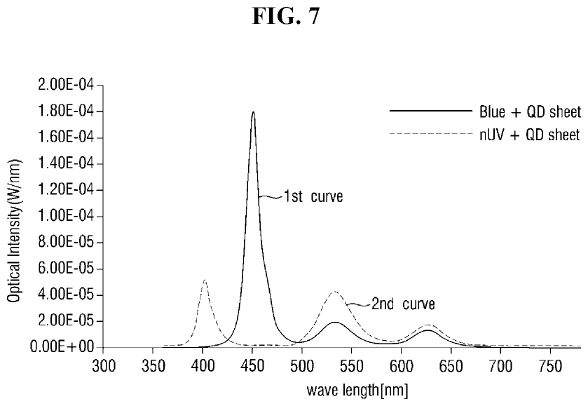

FIG. 7 is a graph for comparing the amount of light exiting from the wavelength conversion layer when the light source emits a blue light with the amount of the light exiting from the wavelength conversion layer when the light source emits a near-ultraviolet light.

The wavelength conversion materials illustrated in FIG. 7 may be the first wavelength conversion material 13g and the second wavelength conversion material 13r described above with respect to FIG. 5. In the graph shown in FIG. 7, the x-axis represents the wavelength (nm) of the light source 30, and the y axis represents the luminous flux (total amount of light emitted from the light source) according to the wavelength of the light source 30. Typically, the brightness increases as the luminous flux increases.

Referring to FIG. 7, a first curve indicated by a solid line represents the luminous flux versus wavelength band when the light source 30 that emits blue light is employed, and a second curve indicated by a dashed line represents the luminous flux versus wavelength band when the light source 30 that emits near-ultraviolet light is employed.

As shown in FIG. 7, even when light of the same intensity is incident, the luminous fluxes versus wavelength band may be different depending on the type of the light source 30.

Specifically, even when the light of the same intensity is incident, the amount of the exiting light at the wavelength of 400 nm when the light source 30 that emits near-ultraviolet light is used (indicated by the second curve) may be reduced by approximately 3.6 times as compared to the amount of the exiting light at the wavelength of 450 nm when the light source 30 that emits blue light is used (indicated by the first curve) because the light absorption efficiency of the first wavelength conversion material 13g and the second wavelength conversion material 13r increases when the light source emits the near-ultraviolet light, compared to when the light source is the blue light. Accordingly, the near-ultraviolet light has been converted into a green light or red light having different wavelength bands from the wavelength of the incident light more than the blue light is.

As shown in FIG. 7, the amount of the exiting light at the red light wavelength (approximately 620 nm to 670 nm) of the second curve (indicated by the dashed line) slightly increases as compared to the amount of the exiting light at the red light wavelength (approximately 620 nm to 670 nm) of the first curve (indicated by the solid line).

In particular, the amount of the exiting light at the green light wavelength (approximately 520 nm to 570 nm) of the second curve (indicated by the dashed line) increases approximately 2.2 times as compared to the amount of the exiting light at the green light wavelength (approximately 520 nm to 570 nm) of the first curve (indicated by the solid line).

As shown by the graph shown in FIG. 7, when the light source that emits the near-ultraviolet light is used, the amount of light exiting from the first wavelength conversion material 13g is relatively increased as compared to the light source 30 emitting the blue light. Therefore, the amount of the green light is increased when the light source that emits the near ultraviolet light is used, such that the overall brightness may be increased.

Referring back to FIGS. 1 and 2, in an exemplary embodiment, a first protective layer 14 may be disposed on the first low-refractive layer 12 and the wavelength conversion layer 13. The protective layer 14 serves to prevent permeation of impurities such as moisture and oxygen. The first protective layer 14 may include or contain an inorganic material. In one exemplary embodiment, for example, the first protective layer 14 may include at least one selected from silicon nitride, aluminum nitride, zirconium nitride, titanium nitride, hafnium nitride, tantalum nitride, silicon oxide, aluminum oxide, titanium oxide, tin oxide, cerium oxide and silicon oxynitride, or a metal thin film with light transmittance. In an exemplary embodiment, the first protective layer 14 may include or be made of silicon nitride.

The first protective layer 14 may completely cover the first low-refractive layer 12 and the wavelength conversion layer 13 on at least one of the sides. In an exemplary embodiment, the first protective layer 14 may completely cover the first low-refractive layer 12 and the wavelength conversion layer 13 on all of the sides, for example. In an alternative exemplary embodiments, the first low-refractive layer 12 and the wavelength conversion layer 13 may not be completely covered by the first protective layer 14 and may be exposed to the outside on at least one of the sides. In such an embodiment, where one side of each of the first low-refractive layer 12 and the wavelength conversion layer 13 is exposed, other protective member may be further provided to prevent impurities from permeating into the one side of each of the first low-refractive layer 12 and the wavelength conversion layer 13.

The first protective layer 14 may completely overlap the wavelength conversion layer 13 to cover the upper surface of the wavelength conversion layer 13 when viewed from the plan view. The first protective layer 14 may be further extended outwardly to cover the side surfaces of each of the wavelength conversion layer 13 and even the side surfaces of the first low-refractive layer 12. The first protective layer 14 may be in contact with the upper surface and the side surfaces of the wavelength conversion layer 13 and the side surfaces of the first low-refractive layer 12. The first protective layer 14 may be extended to the edge of the upper surface 11a of the light guide plate 11, which is not covered by the first low-refractive layer 12, such that a part of the edge of the first protective layer 14 may come in contact with the upper surface 11a of the light guide plate 11. In an exemplary embodiment, the side surfaces of the first protective layer 14 may be aligned with the side surfaces of the light guide plate 11, respectively.

The thickness of the first protective layer 14 may be less than that of the wavelength conversion layer 13 and may be similar to or less than that of the first low-refractive layer 12. The thickness of the first protective layer 14 may be in a range from about 0.1 μm to about 2 μm. In such an embodiment, the thickness of the first protective layer 14 is about 0.1 μm or greater, such that the first protective layer 14 is allowed to prevent permeation of impurities. In such an embodiment, if the thickness of the first protective layer 14 is 0.3 μm or greater, the first protective layer 14 may effectively prevent the permeation of impurities. The thickness of the first protective layer 14 is preferably 2 μm or less to reduce the thickness and increase the transmittance of the backlight unit 100. In one exemplary embodiment, for example, the thickness of the first protective layer 14 may be approximately 0.4 μm.

The wavelength conversion materials included in the wavelength conversion layer 13 are typically vulnerable to impurities such as moisture and oxygen. When the wavelength conversion film is employed as the wavelength conversion layer, barrier films may be attached on and under the wavelength conversion layer to prevent impurities from permeating into the wavelength conversion layer. According to an alternative exemplary embodiment, where the wavelength conversion layer 13 is formed continuously on the light guide plate 11, the first protective layer 14 and the light guide plate 11 seals the wavelength conversion layer 13 to thereby prevent permeation of the impurities.

Moisture may permeate into the wavelength conversion layer 13 through the top surface, the side surfaces and the bottom surface of the wavelength conversion layer 13. In an exemplary embodiment, as described above, the upper surface and the side surfaces of the wavelength conversion layer 13 are covered and protected by the first protective layer 14, such that the permeation of the impurities is effectively prevented or substantially reduced.

The lower surface of the wavelength conversion layer 13 is in contact with the upper surface of the first low-refractive layer 12. When the first low-refractive layer 12 contains voids VD or is made of an organic material, moisture can travel inside the first low-refractive layer 12, and accordingly impurities may permeate through the lower surface of the wavelength conversion layer 13. According to an exemplary embodiment, the first low-refractive layer 12 is also sealed, such that permeation of impurities through the lower surface of the wavelength conversion layer 13 is effectively prevented.

In an exemplary embodiment, the side surfaces of the first low-refractive layer 12 are covered and protected by the first protective layer 14, such that the permeation of the impurities through the side surfaces of the first low-refractive layer 12 is substantially reduced. Even if the first low-refractive layer 12 protrudes from the wavelength conversion layer 13 so that a part thereof is exposed, the protruding part can be covered and protected by the first protective layer 14 to suppress the permeation of the impurities through it. The lower surface of the first low-refractive layer 12 is in contact with the light guide plate 11. When the light guide plate 11 include or is made of an inorganic material such as glass, the light guide plate 11 may suppress permeation of impurities, as the first protective layer 14. In such an embodiment, the surfaces of the stack of the first low-refractive layer 12 and the wavelength conversion layer 13 are surrounded and sealed by the first protective layer 14 and the light guide plate 11. Accordingly, even if there is a path, in which impurities can move, in the first low-refractive layer 12, the impurities may not be introduced into the first low-refractive layer 12. As a result, the deterioration of the wavelength conversion particles due to impurities may be prevented or at least mitigated.

The first protective layer 14 may be formed by a deposition or the like. In one exemplary embodiment, for example, the first low-refractive layer 12 may be formed by a chemical vapor deposition on the light guide plate 11, on which the first low-refractive layer 12 and the wavelength conversion layer 13 are sequentially formed. I t is, however, to be understood that the disclosure is not limited thereto. The first protective layer 14 may be formed in a variety of other ways.

In an exemplary embodiment, as described above, the optical member 10 may be implemented as an integrated, single member and may perform the light guide function as well as the wavelength conversion function. By implementing the optical member as the integrated, single member, the process of assembling the display device may become simpler. In such an embodiment, the first low-refractive layer 12 is disposed on the upper surface 11a of the light guide plate 11 of the optical member 10, such that the total reflection is allowed to effectively occur on the upper surface 11a of the light guide plate 11. In such an embodiment, the first low-refractive layer 12 and the wavelength conversion layer 13 are sealed by the first protective layer 14 or the like, such that deterioration of the wavelength conversion layer 13 may be effectively prevented.

The optical film layer 20 is disposed on the upper surface of the first protective layer 14. The optical film layer 20 may improve the light amount and brightness by adjusting the optical characteristics of light passing through the optical member 10. The optical film layer 20 includes a first film 21 and a second low-refractive layer 22, which are formed integrally.

The first film 21 may include a first base material 21_1 and a first optical pattern layer 21_2 disposed on the first base material 21_1. In an exemplary embodiment, the first optical pattern layer 21_2 may be a prism pattern layer.

The first optical pattern layer 21_2 includes convex portions and concave portions, and the second low-refractive layer 22 is disposed over the convex portions and the concave portions. In an exemplary embodiment, the second low-refractive layer 22 is formed directly on the first optical pattern layer 21_2 in a way such that no air layer is disposed between the first optical pattern layer 21_2 and the second low-refractive layer 22. In such an embodiment, the lower surface of the second low-refractive layer 22 has a complementary shape to the upper surface of the first optical pattern layer 21_2 and comes in contact with and coupled with the upper surface of the first optical pattern layer 21_2.

The upper surface of the second low-refractive layer 22 may be substantially flat. The upper surface of the second low-refractive layer 22 may be parallel to the lower surface of the first base material 21_1. A first distance (a) from the vertex of each of the convex portions of the first optical pattern layer 21_2 to the upper surface of the second low-refractive layer 22 may be smaller than a second distance (b) from the vertex of each of the concave portions of the first optical pattern layer 21_2 to the upper surface of the second low-refractive layer 22. In such an embodiment, the upper surface of the second low-refractive layer 22 may not be in point contact with the vertex of each of the convex portions of the first optical pattern layer 21_2.

In such an embodiment, as shown in FIG. 2, the side surfaces of the second low-refractive layer 22 may be aligned with the side surfaces of the first base material 21_1 and the first optical pattern layer 21_2, respectively. In such an embodiment, the side surfaces of the second low-refractive layer 22 may be aligned with the side surfaces of the first protective layer 14 which is in contact with the side surfaces of the wavelength conversion layer 13.

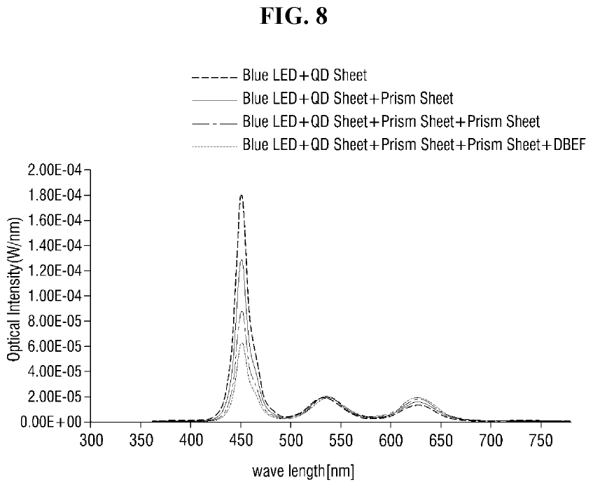

By forming the second low-refractive layer 22 on the first optical pattern layer 21_2, the absorption efficiency of the wavelength conversion layer 13 with respect to the near-ultraviolet light emitted from the light source 30 may be increased, which will hereinafter be described in greater detail with reference to FIGS. 8 to 10.

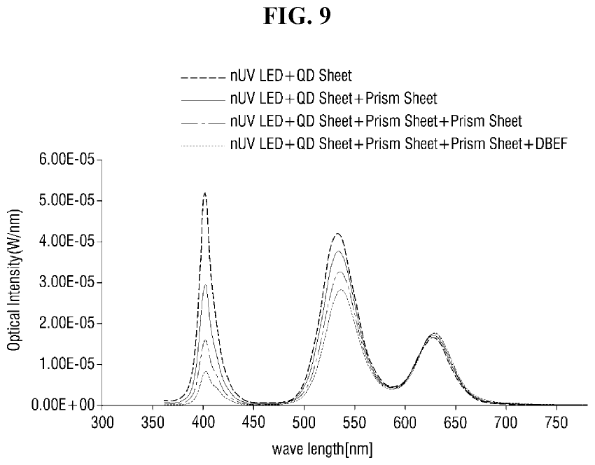

FIG. 8 is a graph for comparing luminous fluxes between optical film layers having different stack structures when a blue light passes therethrough. FIG. 9 is a graph for comparing luminous fluxes between optical film layers having different stack structures when a near-ultraviolet light passes therethrough.

As shown in FIGS. 8 and 9, the luminous flux in the blue light wavelength band tends to decrease as the number of films of the optical film increases when the light source 30 emits blue light or when the light source 30 emits near-ultraviolet light.

On the other hand, the luminous flux in the red light wavelength band slightly increases as the number of films of the optical film increases when the light source 30 emits blue light or when the light source 30 emits near-ultraviolet light. Such a phenomenon may occur because the QDs are excited by the light having a shorter wavelength which is emitted from the light source 30. That is to say, the green QDs can be excited only by the blue light and the near ultraviolet light, but the red QDs can be excited by the green light.

In contrast, the luminous flux in the green light wavelength band rarely changes as the number of films of the optical film increases when the light source 30 emits blue light, while the luminous flux in the green light wavelength band drastically decreases as the number of films of the optical film increases when the light source 30 emits near-ultraviolet light. That is to say, as the number of the films of the optical film increase, the amount of the light exiting from the first wavelength conversion material 13g is more reduced when the light source 30 emits the near-ultraviolet light than when the light source 30 emits the blue light.

Table 1 below shows the brightness values of a 27-inch display module, which are obtained by exciting the wavelength conversion layer with the light source 30 that emits the near ultraviolet light and the light source 30 that emits the blue light. The brightness values change as the number of films of the optical film layer is increased.

TABLE 1

| 27″ Module | Blue LED (Nit) | nUV LED (Nit) |
|---|---|---|
| QD | 178(100%) | 258(100%) |
| QD + Prism | 395(225%) | 448(173%) |
| QD + Prism + Prism | 698(403%) | 762(295%) |
| QD + Prism + Prism + DBEF | 414(233%) | 432(167%) |

Referring to Table 1, the brightness is higher when the light source 30 emits the near-ultraviolet light than when the light source 30 emits the blue light because the absorption efficiently of the wavelength conversion layer 13 is sufficient high. However, the increase in the brightness is lower when the light source 30 emits the near-ultraviolet light than when the light source 30 emits the blue light. In Table 1, a double brightness enhanced film (“DBEF”) is a type of reflective polarizing film. If there is a polarizing film, it would exhibit about twice the brightness, and thus the increase in the brightness would also be twice.

Such a difference of the increase in the brightness may occur for the following reasons: when the light source 30 emits the blue light, the light is concentrated by the optical film layer 20, and the QD recycle effect along the reflection path would occur. In contrast, when the light source 30 emits the near-ultraviolet light, the absorption efficiency by the wavelength conversion layer 13 is sufficiently high, so that the QD recycle effect along the reflection path of the optical film layer would hardly occur and thus the brightness would be increased only by concentrating the light.

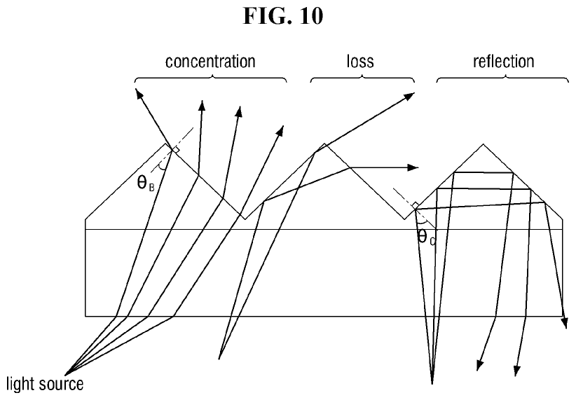

Therefore, when the light source 30 that emits near-ultraviolet light is employed, it is desired to suppress the reflection mechanism of the optical film to further increase the brightness by the optical film layer 20. According to an exemplary embodiment of the disclosure, the backlight unit performs control of the reflection mechanism described above by using the second low-refractive layer 22, which will hereinafter be described in detail with reference to FIG. 10.

FIG. 10 is a view schematically showing various paths in which lights travel after the lights have passed through the prism film.

Referring to FIG. 10, lights may be refracted and reflected after passed through the prism. The refracted lights can be classified into lights concentrated on the display panel to be described later and lost lights. Specifically, the light may be concentrated when the incidence angle is between the Brewster's angle (θ_{B}), which transmits the electric field horizontal component (TM Wave) of the incident light and reflects the electric field vertical component (TE wave) thereof, and zero degree. The light may be refracted when the incidence angle is between the Brewster's angle (θ_{B}) and the total reflection critical angle (θ_{C}). The light may be reflected when the incidence angle is greater than the total reflection critical angle (θ_{C}).

The Brewster's angle can be obtained from the following equation:

$${θ}_{B} = {{sin}^{- 1} ( \begin{matrix}{n}_{t}^{2} \\ {n}_{t}^{2} + {n}_{i}^{2}\end{matrix} )}^{1 / 2}$$

where nᵢ denotes the refractive index of the optical pattern layer, and nₜ denotes refractive index of the medium

The total reflection critical angle can be obtained by the following equation:

$${θ}_{c} = {sin}^{- 1} ( \frac{{n}_{t}}{{n}_{i}} )$$

where nᵢ denotes the refractive index of the optical pattern layer, and nₜ denotes refractive index of the medium

According to an exemplary embodiment of the disclosure, the first optical pattern layer 21_2 may be a prism pattern layer. Therefore, in an exemplary embodiment where the refractive index of the first optical pattern layer 21_2 is approximately 1.55, when the incident light exits from the first optical pattern layer 21_2 to the air having the refractive index of approximately one, the total reflection critical angle (θ_{C}) is about 40.17 degrees and the Brewster's angle (is about 32.8 degrees. Accordingly, the light may be concentrated when the incidence angle of the light from the light source 30 is in a range from 0 degree to about 32.8 degrees. The light may be refracted when the incidence angle is in a range from about 32.8 degrees to about 40.17 degrees. The light may be reflected when the incidence angle is in a range from about 40.17 degrees to 90 degrees.

As described above, to suppress the reflection mechanism of the incident light, it is desired to increase the total reflection critical angle to thereby reduce the reflected light. In one exemplary embodiment, for example, when the incident light exits from the first optical pattern layer 21_2 having a refractive index of approximately 1.55 to the second low-refractive layer 22 having a refractive index of approximately 1.2, the total reflection critical angle (θ_{C}) is about 50.7 degrees, and the Brewster's angle (θ_{B}) is about 37.7 degrees. Accordingly, in such an embodiment, the light may be concentrated when the incidence angle of the light from the light source 30 is in a range from 0 degree to about 37.7 degrees. The light may be refracted when the incidence angle is in a range from about 37.7 degrees to about 50.7 degrees. The light may be reflected when the incidence angle is in a range from about 50.7 degrees to about 90 degrees.

That is to say, when the refractive index of the medium forming the optical interface with the first optical pattern layer 21_2 having the refractive index of 1.55 increases from one to 1.2, the Brewster's angle (θ_{B}) increases from about 32.82 degrees to about 37.7 degrees such that the light is concentrated in a wider range, and the total reflection critical angle (θ_{C}) increases from about 40.17 degrees to about 50.7 degrees such that the light is reflected in a smaller range.

In an exemplary embodiment, the refractive index of the second low-refractive layer 22 may be in the range of about 1.2 to about 1.28 to suppress the reflection mechanism of the incident light. Typically, the fabricating cost is exponentially increased as the refractive index of a solid medium approaches one. If the refractive index of the first low-refractive layer 22 is 1.2 or more, the fabricating cost may not be substantially increased. On the other hand, as the refractive index of the second low-refractive layer 22 approximates that of the second optical pattern layer 23_2, the total reflection critical angle increases such that the amount of reflected light may be reduced. Typically, it becomes more difficult to modulate light at the optical interface between the first optical pattern layer 21_2 and the second low-refractive layer 22. As described above, when the refractive index of the second low-refractive layer 22 is 1.28 or less, the efficiently of light concentration may be substantially improved. In an exemplary embodiment, the second low-refractive layer 22 having a refractive index of approximately 1.2 may be employed. According to an exemplary embodiment of the disclosure, the refractive index of the first low-refractive layer 12 may be equal to the refractive index of the second low-refractive layer 22

In an exemplary embodiment, the second low-refractive layer 22 may include particles and voids order to achieve the above-described low refractive index. In such an embodiment, particles and voids of the second low-refractive layer 22 are substantially the same as those described above with respect to the first low-refractive layer 12, and any repetitive detailed description thereof will be omitted.

Hereinafter, a backlight unit according to alternative exemplary embodiments of the disclosure will be described. I n the following description, the same or similar elements will be denoted by the same or similar reference numerals, and any repetitive detailed description thereof will be omitted or simplified.

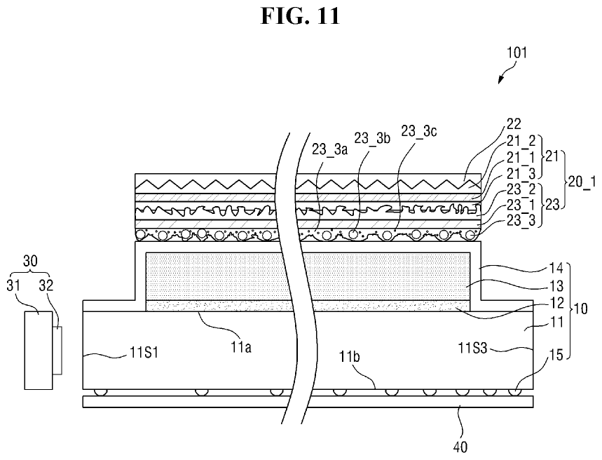

FIGS. 11 to 14 are cross-sectional views of a backlight unit according to various exemplary embodiments.

According to the exemplary embodiments of the backlight unit 101, 102, 103 and 104 shown in FIGS. 11 to 14, the optical film layer of the backlight unit may have a variety of stack structures.

An optical film layer 20_1 of FIG. 11 is substantially to the same as the optical film layer 20 of FIG. 2 except that the optical film layer 20_1 further includes a second film 23.

In an exemplary embodiment, as shown in FIG. 11, the second film 23 may include a second base material 23_1, a light-blocking layer 23_3 disposed on the lower surface of the second base material 23_1, and a second optical pattern layer 23_2 disposed on the upper surface of the second base material 23_1.

The light-blocking layer 23_3 is disposed at the bottom of the second film 23. The light-blocking layer 23_3 is located at the bottom of the optical film layer 20_1 and serves to dilute the bright portion and dark portion by scattering the incident light. The light-blocking layer 23_3 may include a binder 23_3a, organic particles 23_3b dispersed in the binder 23_3a and inorganic particles 23_3c dispersed in the binder 23_3a. The organic/inorganic particles may mean organic/inorganic beads, fillers, respectively, for example. The organic/inorganic particles may be shaped particles such as spherical, flat plate, core-shell and the like, or may be amorphous particles. In such an embodiment, particles of various shapes may be mixed.

The organic/inorganic particles 22_3b and 22_3c may be dispersed throughout the light-blocking layer 23_3. The inorganic particles 23_3c may be dispersed not only in the convex portions but also in the concave portions. Although the organic particles 23_3b may be mainly located in the convex portions, the organic particles 23_3b may be dispersed also in the concave portions. In some exemplary embodiments, the organic/inorganic particles 23_3b and 23_3c may be randomly dispersed throughout the light-blocking layer 23_3, but the density thereof may be substantially constant or uniform.

The second optical pattern layer 23_2 may have an irregular surface and may include concave portions and convex portions. A first coupling resin layer 21_3 is formed on the lower surface of the first base material 21_1 of the first film 21. Some of the convex portions of the second optical pattern layer 23_2 are in contact with or partially penetrate into the first coupling resin layer 21_3 to be coupled with the first coupling resin layer 21_3. An air layer is disposed between the concave portions of the second optical pattern layer 23_2 and the first coupling resin layer 21_3.

Depending on the shape of the second optical pattern layer 23_2 of the second film 23, the air layer between the first film 21 and the second film 23 may be entirely continuous or may be divided into a plurality of islands.

In an exemplary embodiment, the second optical pattern layer 23_2 may be a diffusion layer, and the first optical pattern layer 21_2 may be a prism pattern layer.

The light incident through the light-blocking layer 23_3 passes through the second base material 23_2 and the second optical pattern layer 23_2, and then exits upwardly. A part of the second optical pattern layer 23 2 is surrounded by the first coupling resin layer 21_3 of the first film 21 such that the second optical pattern layer 23_2 and the first coupling resin layer 21_3 form an interface. In such an embodiment, another part of the second optical pattern layer 23_2 forms an interface with the air layer. Light is refracted at the interface according to the Snell's law. Since the refractive index of the air layer is less than that of the first coupling resin layer 21_3, the light is refracted differently at the interface with the first coupling resin layer 21_3 from at the interface with the air layer. Furthermore, since the surface of the second optical pattern layer 23_2 of the second film 23 is irregular, the light may exit at more different directions. In this manner, light may be allowed to exit at a variety of directions, thereby improving uniformity of luminance by further diluting the bright and dark portions.

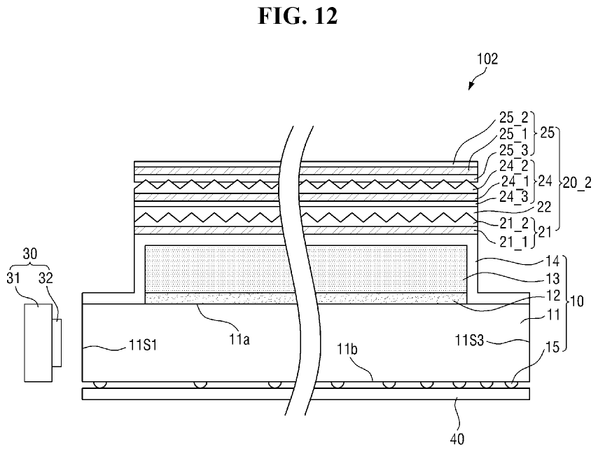

An optical film layer 20_2 of FIG. 12 is substantially to the same as the optical film layer 20 of FIG. 2 except that the optical film layer 20_2 further includes a third film 24 and a fourth film 25.

In an exemplary embodiment, as shown in FIG. 12, the third film 24 may include a third base material 24_1, a second coupling resin layer 24_3 disposed on the lower surface of the third base material 24_1, and a third optical pattern layer 24_2 disposed on the upper surface of the third base material 24_1. Alternatively, The second coupling resin layer 24_3 may be omitted and the lower surface of the third base material 24_1 may be disposed on the upper surface of the second low-refractive layer 22.

The fourth film 25 may include a fourth base material 25_1, a third coupling resin layer 25_3 disposed on the lower surface of the fourth base material 25_1, and an optical layer 25_2 disposed on the upper surface of the fourth base material 25_1.

The third optical pattern layer 24_2 includes convex portions and concave portions. Some of the convex portions are in contact with or partially penetrate into the third coupling resin layer 25_3 to be coupled with the third coupling resin layer 25_3. An air layer is disposed between the concave portions of the third optical pattern layer 24_2 and the third coupling resin layer 25_3.

In an exemplary embodiment, the third optical pattern layer 24_2 may be a prism pattern layer, and the optical layer 25_2 of the fourth film 25 may be a DBEF.

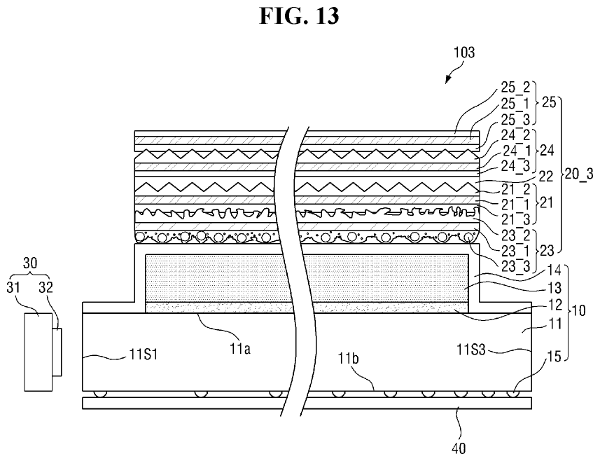

An optical film 20_3 of FIG. 13 is substantially to the same as the optical film layer 20 of FIG. 2 except that the optical film 20_3 further includes a second film 23, a third film 24 and a fourth film 25.

In an exemplary embodiment, as shown in FIG. 13, the second film 23 may include a second base material 23_1, a light-blocking layer 23_3 disposed on the lower surface of the second base material 23_1, and a second optical pattern layer 23_2 disposed on the upper surface of the second base material 23_1.

The second optical pattern layer 23_2 may have an irregular surface and may include concave portions and convex portions. A first coupling resin layer 21_3 is disposed on the lower surface of the first base material 21_1 of the first film 21. Some of the convex portions are in contact with or partially penetrate into the first coupling resin layer 21_3 to be coupled with the first coupling resin layer 21_3. An air layer is disposed between the concave portions of the second optical pattern layer 23_2 and the first coupling resin layer 21_3.

The third film 24 may include a third base material 24_1, a second coupling resin layer 24_3 disposed on the lower surface of the third base material 24_1, and a third optical pattern layer 24_2 disposed on the upper surface of the third base material 24_1. Alternatively, the second coupling resin layer 24_3 may be omitted and the lower surface of the third base material 24_1 may be disposed on the upper surface of the second low-refractive layer 22.

The fourth film 25 may include a fourth base material 25_1, a third coupling resin layer 25_3 disposed on the lower surface of the fourth base material 25_1, and an optical layer 25_2 disposed on the upper surface of the fourth base material 25_1.

The third optical pattern layer 24_2 includes convex portions and concave portions. Some of the convex portions are in contact with or partially penetrate into the third coupling resin layer 25_3 to be coupled with the third coupling resin layer 25_3. An air layer is disposed between the concave portions of the third optical pattern layer 24_2 and the third coupling resin layer 25_3.

In an exemplary embodiment, the second optical pattern layer 23_2 may be a scattering layer, the third optical pattern layer 24_2 may be a prism pattern layer, and the optical layer 25_2 of the fourth film 25 may be a DBEF.

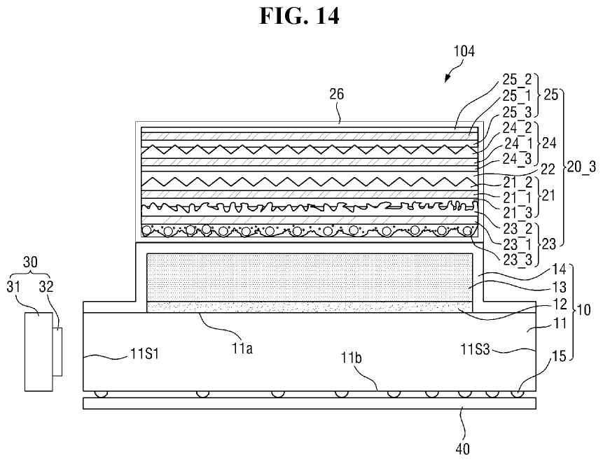

The exemplary embodiment shown in FIG. 14 is different from the exemplary embodiment shown in FIG. 13 in that the former further includes a second protective layer 26.

Referring to FIG. 14, the second protective layer 26 may completely overlap a first film 21, a second film 23, a second low-refractive layer 22, a third film 24, and a fourth film 25. The second protective layer 26 may be in contact with the lower surface of the second film 23, the side surfaces of the first film 21, the second film 23, the second low-refractive layer 22, the third film 24 and the fourth film 25, and the upper surface of the fourth film 25. In an exemplary embodiment, one side surface of the second protective layer 26 may be aligned with at least one side surface of the first protective layer 14.

The second protective layer 26 serves to prevent permeation of impurities such as moisture and oxygen. The second protective layer 26 may include or contain an inorganic material. In one exemplary embodiment, for example, the second protective layer 26 may include at least one selected from silicon nitride, aluminum nitride, zirconium nitride, titanium nitride, hafnium nitride, tantalum nitride, silicon oxide, aluminum oxide, titanium oxide, tin oxide, cerium oxide and silicon oxynitride, or a metal thin film with light transmittance. In an exemplary embodiment, the second protective layer 26 may include or be made of silicon nitride.

The first film 21, the second film 23, the second low-refractive layer 22, the third film 24 and the fourth film 25 may be optical films completely surrounded and sealed by the second protective layer 26, such that the permeation of moisture/oxygen may be effectively prevented.

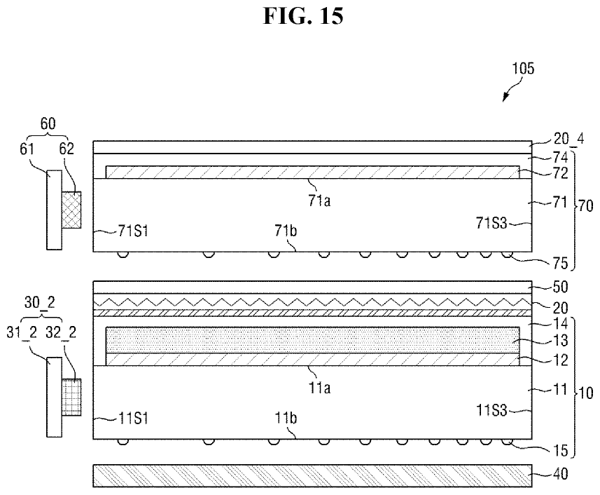

FIG. 15 is a cross-sectional view of a backlight unit according to another alternative exemplary embodiment of the disclosure.

The exemplary embodiment of FIG. 15 illustrates that the light sources 30_2 and 60 of the backlight unit 105 can be variously modified.

The exemplary embodiment of FIG. 15 is different from the exemplary embodiment of FIG. 2 in that the former further includes an optical filter 50, a second light source 60, a second optical member 70, and a second optical film layer 20_4.

The light source 30_2 shown in FIG. 15 is substantially identical to the light source 30 of FIG. 2 except that the former includes light-emitting elements 32_2 that emit a near-ultraviolet light only on a printed circuit board 31_2. The optical film layers 20 described above with respect to the exemplary embodiments shown in FIGS. 11 to 14 may be employed. It is to be noted that the fourth film 25 is included in the second optical film layer 20_4 and is eliminated from the optical film according to the exemplary embodiments of FIGS. 12 to 14.

Hereinafter, the optical filter 50, the second light source 60, the second optical member 70 and the second optical film layer 20_4 will be described in detail.

The second optical member 70 may be disposed above the optical member 10. In an exemplary embodiment, the second optical member 70 may include a second light guide plate 71, a third low-refractive layer 72 disposed on the second light guide plate 71, and a third protective layer 74 disposed on the third low-refractive layer 72. In such an embodiment, the second optical member 70 may further include a second scattering pattern 75 disposed on the lower surface 71b of the second light guide plate 71.

The second optical member 70 may have substantially the same structure as the optical member 10 described above except for the wavelength conversion layer 13. Such an embodiment, the elements of the second optical member 70 may be substantially to the same as those of the optical member 10.

The second light guide plate 71 serves to guide the path of light. The second light guide plate 71 may have a generally polygonal column shape. The shape of the second light guide plate 71 may be, but is not limited to, a rectangle when viewed from the top. In an exemplary embodiment, the second light guide plate 71 has a rectangular hexahedron shape looking like a rectangle when viewed from the top and may include an upper surface 71a, a lower surface 71b and four side surfaces.

The area and thickness of the second light guide plate 71 are shown to be the same as those of the light guide plate 11, but the disclosure is not limited thereto. The area of the second light guide plate 71 when viewed from the top plan view and the cross-sectional thickness may be larger or smaller than those of the light guide plate 11.

A second scattering pattern 75 may be disposed on the lower surface 71b of the second light guide plate 71. The second scattering pattern 75 serves to change the angle of the light traveling in the second light guide plate 71 by total reflection so that the light exits out of the second light guide plate 71.

The second light guide plate 71 may include an inorganic material. In one exemplary embodiment, for example, the second light guide plate 71 may be made of, but is not limited to, glass.

The backlight unit 104 may include the second light source 60 disposed on and facing one side face of the light guide plate 11.

The second light source 60 may be disposed adjacent to at least one side face of the second light guide plate 71. In an exemplary embodiment, a printed circuit board 61 and a plurality of second light-emitting elements 62 mounted on the printed circuit board 61 are disposed adjacent to the side face 71S1 located at the longer side of the second light guide plate 71, but the disclosure is not limited thereto. In one exemplary embodiment, for example, the second light-emitting elements 62 may be disposed adjacent to either side faces 71S1 and 71S3 on the longer sides, respectively, or may be disposed adjacent to one or both of the side faces 71S2 and 71S4 on the shorter sides, respectively.

The second light-emitting elements 62 may emit a blue light. In such an embodiment, the light emitted from the second light-emitting elements 62 may be light in a blue wavelength band. In an exemplary embodiment, the blue light emitted from the second light-emitting elements 62 may have a peak wavelength between about 430 nm and about 470 nm. The blue light emitted from the light-emitting elements 62 may be incident into the second light guide plate 11 through the light incidence surface.

The third low-refractive layer 72 is disposed on the upper surface 71a of the second light guide plate 71. The third low-refractive layer 72 may be formed directly on the upper surface 71a of the second light guide plate 71 and may come in contact with the upper surface 71a of the second light guide plate 71. The third low-refractive layer 72 is disposed on the second light guide plate 71 to facilitate the total reflection of the second light guide plate 71.

Although not shown in the drawings, a barrier layer may be further disposed between the third low-refractive layer 72 and the second light guide plate 71.

A third protect layer 74 may be disposed on the third low-refractive layer 72. The third protective layer 74 may effectively prevent permeation of impurities such as moisture and oxygen. The third protective layer 74 may include or contain an inorganic material.

The third protective layer 74 may completely cover the third low-refractive layer 72 on at least one of the sides. In an exemplary embodiment, the third protective layer 74 may completely cover the third low-refractive layer 72 on all of the sides, for example. In some exemplary embodiments, the third low-refractive layer 72 may not be covered by the third protective layer 74 and may be exposed to the outside on at least one of the sides. In such an embodiment, where one side of the third low-refractive layer 72 and the wavelength conversion layer 13 is exposed, the exposed side may be protected by other protective member from permeation of impurities.

The third protective layer 74 may be formed by a deposition or the like. In one exemplary embodiment, for example, the third protective layer 74 may be formed by a chemical vapor deposition on the second light guide plate 71 on which the third low-refractive layer 72 is formed. It is, however, to be understood that the disclosure is not limited thereto. The third protective layer 74 may be formed in a variety of other ways.

The second optical film layer 20_4 may be disposed on the third protective layer 74. The second optical film layer 20_4 includes a base material, a coupling resin layer (not shown) disposed on the lower surface of the base material, and an optical layer (not shown) disposed on the upper surface of the base material. According to an exemplary embodiment of the disclosure, the optical layer may be a DBEF. Although not shown in the drawings, a polarizing film may be disposed on the upper surface of the second optical film layer 20_4.

The second optical member 70 may be implemented as an integrated, single member and may perform the light guiding function, as the optical member 10 described above. By implementing the second optical member as the integrated, single member, the process of assembling the display device may become simpler.

The optical filter 50 may be disposed between the optical member 10 and the second optical member 70. The optical filter 50 may transmit light in a particular wavelength band and reflect light in the other wavelength bands. In one exemplary embodiment, for example, the optical filter generally transmits light having a wavelength longer than about 480 nm, and does not transmit light having a wavelength shorter than about 480 nm. In such an embodiment, the optical filter may be a long-pass filter that transmits light of a long wavelength and reflects light of a short wavelength.

In one exemplary embodiment, for example, light having a long wavelength longer than about 480 nm may include a green light having a peak wavelength between about 520 nm and about 570 nm, or a red light having a peak wavelength between about 620 nm and about 670 nm. Light having a short wavelength shorter than 480 nm may be a blue light having a peak wavelength between about 430 nm and about 470 nm. In such an embodiment, the optical filter may transmit the green light and the red light while reflect the blue light.

In such an embodiment, as described above, the optical filter 50 is disposed between the optical member 10 and the second optical member 70. According to an exemplary embodiment of the disclosure, the optical filter 50 may be implemented as a separate filter member and may be attached to the optical member 10 by an adhesive material such as an OCR and an OCA. In an alternative exemplary embodiment, the optical filter 50 may be formed directly on the optical member 10. In such an embodiment, the light guide plate 11 may be formed through continuous processes. In another alternative exemplary embodiment, the optical filter 50 may be spaced apart from the optical member 10 and the second optical member 70. In such an embodiment, an air layer may be formed between the optical member 10 and the optical filter 50 and between the second optical member 70 and the optical filter 50.

The backlight unit 104 may further include a reflection member 40 disposed under the optical member 10. The reflection member 40 may include a reflective film or a reflective coating layer. The reflection member 40 reflects the light exiting through the lower surface 11b of the light guide plate 11 of the optical member 10 back to the inside of the light guide plate 11.

As described above, the first light source 30_2 may be disposed adjacent to one side of the light guide plate 11, and the second light source 60 may be disposed adjacent to one side of the second light guide plate 71. The first light source 30_2 may emit near-ultraviolet light having a peak wavelength between about 390 nm and about 410 nm, and the second light source 60 may emit blue light having a peak wavelength between about 430 nm and about 470 nm.

Near-ultraviolet light emitted from the first light source 30_2 may travel in various directions. A part of the near-ultraviolet light emitted toward the lower surface of the light guide plate 11 may be reflected at the lower surface of the light guide plate 11 toward the upper side. Another part of the near-ultraviolet light which is not reflected at the lower surface of the light guide plate 11 may be reflected upwardly by the reflection member 40 disposed under the light guide plate 11.

In one exemplary embodiment, for example, a part of the near-ultraviolet light emitted from the first light source 30_2 may be reflected at the lower surface of the light guide plate 11 upward, may pass through the wavelength conversion layer 13 to be converted into a first red light and a first green lower, and may exit. Some of the light that is not reflected at the lower surface of the light guide plate 11 may be reflected upward by the reflection member 40. The light reflected upward by the reflection member 40 may pass through the wavelength conversion layer 13 to be converted into a second red light and a second green light, and then exit. The first and second red lights and the first and second green lights may pass through the optical filter 50 without being reflected.

In addition, the blue light emitted from the second light source 60 may travel in various directions as well. A part of the light emitted toward the lower surface of the second light guide plate 71 may be reflected at the lower surface of the second light guide plate 71 toward the upper side and may exit as a first blue light. Another part of the light which is not reflected at the lower surface of the second light guide plate 71 may be reflected upwardly by the reflection member 40 disposed under the second light guide plate 71 and then exit as a second blue light.

As a result, the lights exiting to the outside may include all of the first and second red light, the first and second green light, and the first and second blue light. In such an embodiment, white light or light of different colors may be represented by adjusting the ratio of the exiting lights of different colors as desired.

Conventionally, a backlight unit employs a light source that emits a blue light only. As the blue light passes through the wavelength conversion layer, the intensity of the blue light becomes weak, and the light conversion efficiency of the blue light was not high. In an exemplary embodiment, as shown in FIG. 15, the near-ultraviolet light having high light conversion efficiency is used to convert the light into green light and red light as described above. In such an embodiment, the blue light does not pass through the wavelength conversion layer, and thus the amount of the blue light does not decrease. Therefore, even if both the near-ultraviolet light source and the blue light source are used, the sum of the power consumptions for driving the backlight unit including the two types of light sources may be lower than the power consumption for driving a conventional backlight unit including only the blue light source.

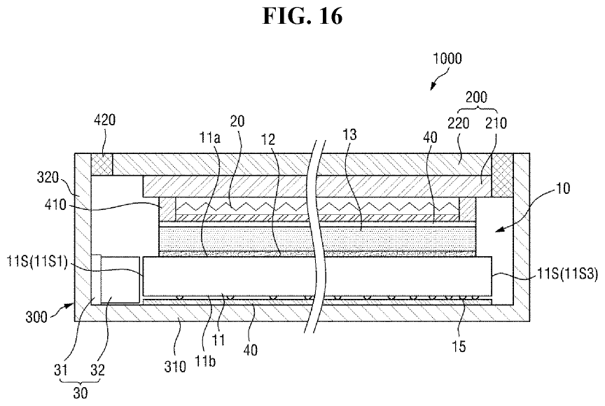

FIGS. 16 to 18 are cross-sectional views of display devices according to exemplary embodiments of the disclosure.

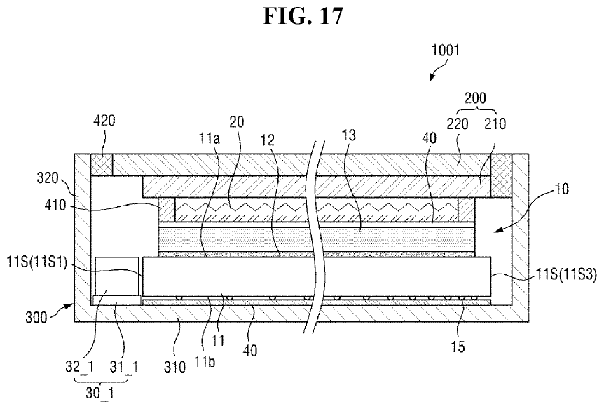

Referring to FIGS. 16 and 17, in an exemplary embodiment, a display device 1000; 1001 includes a light source 30; 30_1, an optical member 10 disposed on the path in which the light source 30; and 30_1 emits the light, an optical film layer 20 disposed on the optical member 10, and a display panel 200 disposed above the optical film layer 20.

The optical film layer 20 may be any one of the exemplary embodiment of the optical film described herein. In an exemplary embodiments shown in FIGS. 16 and 17, the optical film of FIG. 2 is employed.

The light source 30; 30_1 is disposed on one side of the optical member 10. The light source 30; 30_1 may be disposed adjacent to the light incidence surface 1151 of the light guide plate 11 of the optical member 10. The light source 30; 30_1 may include either point light sources or a line light source. The point light sources may be LEDs 32; 32_1. The plurality of LEDs 32; 32_1 may be mounted on a printed circuit board 31; 31_1. The LEDs 32; 32_1 may emit near-ultraviolet light and light in a blue wavelength.

In an exemplary embodiment, the LEDs 32 may be top-emitting LEDs that emit light upward or in a direction opposite to the printed circuit board 31 therebelow, as shown in FIG. 16. In such an embodiment, the printed circuit board 31 may be disposed on the side wall 320 of the housing 300.

In an alternative exemplary embodiment, the LEDs 32_1 may be a top-emitting LED that emits light to the side, as shown in FIG. 17. In such an embodiment, the printed circuit board 31_1 may be disposed on the bottom 310 of the housing 300.

The near-ultraviolet light and the light in a blue wavelength emitted from the LEDs 32; 32_1 are incident on the light guide plate 11 of the optical member 10. The light guide plate 11 of the optical member 10 guides light and outputs the light through the upper surface 11a or the lower surface 11b of the light guide plate 11. The wavelength conversion layer 30 of the optical member 10 converts a part of the near-ultraviolet light and the light of the blue wavelength incident from the light guide plate 11 into other wavelengths such as a green wavelength and a red wavelength. The converted lights of green wavelength and red wavelength exit upward toward the display panel 200 together with the unconverted light of blue wavelength and the near-ultraviolet light.

The display device 1000; 1001 may further include a reflection member 40 disposed below the optical member 10. The reflection member 40 may include a reflective film or a reflective coating layer. The reflection member 40 reflects the light exiting through the lower surface 11b of the light guide plate 11 of the optical member 10 back to the inside of the light guide plate 11.

The display panel 200 is disposed above the optical member 10. The display panel 200 receives light from the optical member 10 to display images. In an exemplary embodiment, the display panel 200 may be a liquid-crystal display panel, or an electrophoretic panel, for example. Hereinafter, for convenience of description, exemplary embodiments where the display panel 200 is a liquid-crystal display panel will be described in detail, but not being limited thereto. Alternatively, a variety of other light-receiving display panels may be employed as the display panel 200.

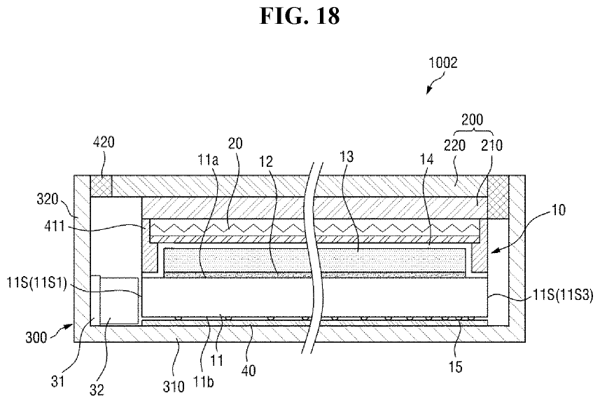

The display panel 200 may include a first substrate 210, a second substrate 220 facing the first substrate 210, and a liquid-crystal layer (not shown) disposed between the first substrate 210 and the second substrate 220. The first substrate 210 and the second substrate 220 overlap each other. In an exemplary embodiment, one of the substrates may be larger than the other substrate so that the one of the substrates may protrude further outward as shown in FIGS. 17 and 18. In one exemplary embodiment, for example, the second substrate 220 located above the first substrate 210 is larger than the first substrate 210 and may protrude from the side where the light source 30; 30_1 is disposed, as shown in FIGS. 16 to 18. The protruding part of the second substrate 220 may provide a space for mounting a driving chip or an external circuit board. Alternatively, the first substrate 210 located below the second substrate 220 may be larger than the second substrate 220 and protrude outward. In the display panel 200, the first substrate 210 and the second substrate 220 overlap each other, except for the protruding part, may be substantially aligned with the side surface of the light guide plate 11 of the optical member 10.

The optical member 10 may be coupled with the display panel 200 through an inter-module coupling member 410. The inter-module coupling member 410 may have a rectangular frame shape when viewed from the top plan view. The inter-module coupling member 410 may be positioned at the edge of each of the display panel 200 and the optical member 10.

In an exemplary embodiment, the bottom surface of the inter-module coupling member 410 is disposed on the upper surface of the first protective layer 14 of the optical member 10. The side surfaces of the inter-module coupling member 410 may be aligned with the side surfaces of the optical member 10, respectively.

The inter-module coupling member 410 may include a polymer resin, an adhesive tape, or the like.

In some exemplary embodiments, the inter-module coupling member 410 may include a light-absorbing material such as a black pigment and a dye, or may include a reflective material to block light transmission.

In an exemplary embodiment, as shown in FIGS. 16 and 17, the display device 1000; 1001 may further include the housing 300. The housing 300 has an open surface and includes a bottom 310 and side walls 320 connected to the bottom 310. The optical member 10, the optical film layer 20, the light source 30;30_1, the reflection member 40 and the display panel 200 may be accommodated in the space defined by the bottom 310 and the side walls 320. The light source 30; 30_1 and the reflection member 40 are disposed on the bottom 310 of the housing 300. The height of the side walls 320 of the housing 300 may be substantially equal to the total height of the optical member 10, the optical film layer 20 and the display panel 200 placed inside the housing 300. The display panel 200 is disposed adjacent to the upper end of the side walls of the housing 500, and the display panel 200 and the upper end of the side walls of the housing 500 may be coupled with each other by a housing coupling member 420. The housing coupling member 420 may have a rectangular frame shape when viewed from the top plan view. The housing coupling member 420 may include a polymer resin, an adhesive tape, or the like.

FIG. 18 is a cross-sectional view of a display device according to another alternative exemplary embodiment of the disclosure. FIG. 18 shows a modification of the arrangement of the inter-module coupling members 411. Referring to FIG. 18, the inter-module coupling member 411 of the display device 1002 is different from that of the exemplary embodiment shown in FIG. 16 in that the former further extends outwardly on the protective layer 14 to be in contact with the side surfaces 13s of the wavelength conversion layer 13. In such an embodiment, the inter-module coupling member 411 may be extended to the protective layer 14 in contact with the upper surface 11a of the light guide plate 11. In an exemplary embodiment, the outer side surface of the inter-module coupling member 411 may be aligned with the side surface 11S of the light guide plate 11. In such an embodiment, the outer side surface of the inter-module coupling members 411 may be aligned with the area where the first substrate 210 overlaps the second substrate 220, i.e., the side surface of the first substrate 210 which is smaller than the second substrate 220.

While the invention has been particularly shown and described with reference to exemplary embodiments thereof, it will be understood by those of ordinary skill in the art that various changes in form and details may be made therein without departing from the spirit or scope of the invention as defined by the following claims.

What is claimed is:

1. A backlight unit comprising:
a light guide plate;
a wavelength conversion layer disposed on the light guide plate; and
an optical film disposed on the wavelength conversion layer, wherein the optical film comprises:
a first film comprising a prism pattern layer; and
a first low-refractive layer disposed on the first film and having a complementary shape to the prism pattern layer, and
wherein the first low-refractive layer has a refractive index less than a refractive index of the first film.

2. The backlight unit of claim 1, wherein the refractive index of the first low-refractive layer is in a range from about 1.2 to about 1.28.

3. The backlight unit of claim 1, wherein an upper surface of the first low-refractive layer is parallel to a lower surface of the first film.

4. The backlight unit of claim 3, wherein
the prism pattern layer comprises convex portions and concave portions, and
a first distance from a vertex of each of the convex portions to the upper surface of the first low-refractive layer is smaller than a second distance from a vertex of each of the concave portions to the upper surface of the first low-refractive layer.

5. The backlight unit of claim 1, further comprising:
a second low-refractive layer between the light guide plate and the wavelength conversion layer,
wherein the second low-refractive layer is in contact with the light guide plate.

6. The backlight unit of claim 5, wherein a refractive index of the second low-refractive layer is equal to the refractive index of the first low-refractive layer.

7. The backlight unit of claim 6, further comprising:
a light source disposed adjacent to a side of the light guide plate.

8. The backlight unit of claim 7, wherein
the light source emits a first light and a second light,
the first light is a near-ultraviolet light having a peak wavelength between about 390 nm and about 410 nm, and
the second light is a blue light having a peak wavelength between about 430 nm and about 470 nm.

9. The backlight unit of claim 7, wherein
the wavelength conversion layer comprises a first wavelength conversion material and a second wavelength conversion material,
wherein the first wavelength conversion material converts light emitted from the light source into a green light, and
the second wavelength conversion material converts the light emitted from the light source into a red light.

10. The backlight unit of claim 1, further comprising:
a second film disposed between the first film and the wavelength conversion layer, wherein the second film comprises a scattering layer.

11. The backlight unit of claim 10, wherein the optical film further comprises:
a third film comprising a prism pattern disposed on the first low-refractive layer; and
a fourth film comprising a reflective polarizing layer.

12. The backlight unit of claim 11, wherein the optical film further comprises a protective layer,
wherein the protective layer is in contact with a lower surface of the first film, in contact with side surfaces of each of the first film, the second film and the first low-refractive layer, and in contact with an upper surface of the first low-refractive layer.

13. The backlight unit of claim 1, further comprising:
a reflection member disposed under the light guide plate.

14. The backlight unit of claim 13, wherein the light guide plate comprises a scattering pattern disposed on a surface opposite to a surface facing the wavelength conversion layer.

15. A display device comprising:
a backlight unit comprising a light guide plate, a wavelength conversion layer disposed on the light guide plate, an optical film disposed on the wavelength conversion layer, and a light source disposed on a side of the light guide plate; and
a display panel disposed above the backlight unit,
wherein the optical film comprises
a first film comprising a prism pattern layer, and
a first low-refractive layer disposed on the first film and having a complementary shape to the prism pattern layer, and
wherein the first low-refractive layer has a refractive index less than a refractive index of the first film.

16. The display device of claim 15, wherein the refractive index of the first low-refractive layer is in a range from about 1.2 to about 1.28.

17. The display device of claim 16, wherein an upper surface of the first low-refractive layer is parallel to a lower surface of the first film.

18. The display device of claim 17, further comprising:
a second film disposed between the first film and the wavelength conversion layer, wherein the second film comprises a scattering layer.

19. The display device of claim 18, wherein
the light source emits a first light and a second light,
wherein the first light is a near-ultraviolet light having a peak wavelength between about 390 nm and about 410 nm, and
the second light is a blue light having a peak wavelength between about 430 nm and about 470 nm.

20. The display device of claim 19, further comprising:
an inter-module coupling member disposed at an edge of the wavelength conversion layer,
wherein the inter-module coupling member couples the light guide plate with the display panel,
wherein the optical film is disposed in a space surrounded by the light guide plate, the display panel and the inter-module coupling member.
